(19) United States
(12) Patent Application Publication
(10) Pub. No.: US 2009/0271722 A1
(43) Pub. Date: Oct. 29, 2009

(54) METHOD OF PROVIDING GRAPHICAL USER INTERFACE (GUI), AND MULTIMEDIA APPARATUS TO APPLY THE SAME

(75) Inventor: Tae-jun PARK, Gwacheon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/266,641

(22) Filed: Nov. 7, 2008

(30) Foreign Application Priority Data
Apr. 25, 2008 (KR) 2008-38854

(51) Int. Cl. G06F 3/048

(52) U.S. Cl. 715/765

(57) ABSTRACT

A method of providing a graphical user interface (GUI) and a multimedia apparatus using the method. The method includes generating a first item, second item and line connecting the first item and the second item on a screen, and generating a third item according to user additional operations, to enable a user to manipulate items more conveniently and more intuitively.

### CROSS-REFERENCE TO RELATED APPLICATIONS

This application claims priority under 35 U.S.C. §119 (a) from Korean Patent Application No. 10-2008-0038854, filed on Apr. 25, 2008, in the Korean Intellectual Property Office, the disclosure of which is incorporated herein by reference in its entirety.

### BACKGROUND OF THE INVENTION

1. Field of the Invention

The present general inventive concept relates to a method of providing a graphical user interface (GUI), and more particularly, to a method of providing a GUI by which a user is able to operate a multimedia apparatus.

2. Description of the Related Art

Graphical user interfaces (GUI), by which users may select GUI items such as icons, menus, or anchors displayed on display apparatuses which are manipulated using pointers, have become widespread. In order to input user commands in such GUI environments, a user may move a pointer to a desired item using an input device such as a mouse or a touch pad, and may press a specific key on the input device to input a command to execute a specific function of the item indicated by the pointer.

However, movement of the pointer to the desired item using the input device and selection of the moved item may be troublesome to the user. This trouble may be exacerbated when a touch screen of a display apparatus is used together with an input device to manipulate a desired item.

There is demand for a more convenient manipulation method when using a GUI, and accordingly there is a need for methods by which the user may manipulate GUI items more conveniently.

### SUMMARY OF THE INVENTION

The present general inventive concept provides a method of providing a graphical user interface (GUI) which can provide a user with the ability to manipulate items more easily, more conveniently and more intuitively, and a multimedia apparatus to apply the method.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of providing a graphical user interface (GUI), the method including, if a command to generate a first item and a second item is received, generating the first item, the second item, and a line connecting the first item and the second item on a screen, and if a location on the line is selected, generating at the selected location a third item capable of moving on the screen.

The screen may include a map to search for a route.

The line connecting the first item and the second item may be a virtual route, which connects a position of the first item to a position of the second item using a straight line on the map.

The line connecting the first item and the second item may be a route from the position of the first item to the position of the second item.

The first item, second item and third item may be a start item representing a starting point, a destination item representing a destination, and a via item representing a via point, respectively.

The method may further include, if the third item is moved towards an edge of the screen, continuously displaying on the screen an area near to the edge of the screen towards which the third item is moved, and controlling the third item to continue to be moved.

The method may further include, if the first item or second item lies outside the scope of the area displayed on the screen, controlling the first item to be regenerated at a position along a virtual line connecting the first item and the third item, and controlling the second item to be regenerated at a position along a virtual line connecting the second item and the third item.

The third item may be moved on the screen by a dragging operation.

The method may further include, if the third item is generated, controlling the line connecting the first item and the second item to be divided into a line connecting the first item and the third item and a line connecting the third item and the second item.

The method may further include, if a location on the lines generated on the screen is additionally selected, controlling at least one additional item capable of moving on the screen to be generated on the selected location.

The method may further include, if the additional items are generated, controlling the line connecting the first item and the second item to be changed to a line connecting the first item and the second item through the third item and the at least one additional item.

If a user presses locations on the screen for a long period of time, the first item and second item may be generated on the pressed locations on the screen.

The method may further include, if at least one of the items displayed on the screen is circumscribed clockwise or counterclockwise, controlling the screen to be reduced or enlarged.

The method may further include, if the second item is double clicked or if the first item is dragged and dropped onto the second item, guiding a user along a route following the generated line.

The screen may include a touch screen through which a user command is input by touch.

The foregoing and/or other aspects and utilities of the present general inventive concept may further be achieved by providing a multimedia apparatus which may include a touch screen, and a control unit to control a first item, a second item and a line connecting the first item and the second item to be generated on the touch screen, if a command to generate the first item and second item is received, and to control that a third item capable of moving on the touch screen to be generated on a location on the line, if the location on the line is selected.

The touch screen may display a map to enable a search for a route.

The line connecting the first item and the second item may be a virtual route, which connects a position of the first item to a position of the second item using a straight line on the map.

The line connecting the first item and the second item may be a route from the position of the first item to the position of the second item.

The first item, second item and third item may be a start item representing a starting point, a destination item representing a destination and a via item representing a via point, respectively.

If a command to move the third item to an edge of the touch screen is received, the control unit may continuously display on the touch screen an area near to the edge to which the third item is moved, and control the third item to continue to be moved.

If the first item or second item lies outside the scope of the area displayed on the screen, the control unit may control the first item to be regenerated at a position along a virtual line connecting the first item and the third item, and control the second item to be regenerated at a position along a virtual line connecting the second item and the third item.

The control unit may control the third item to be moved on the touch screen by a dragging operation.

If the third item is generated, the control unit may control the line connecting the first item and the second item to be divided into a line connecting the first item and the third item and a line connecting the third item and the second item.

If a location on the lines generated on the touch screen is additionally touched, the control unit may control at least one additional item capable of moving on the screen to be generated on the touched location.

If the additional items are generated, the control unit may control the line connecting the first item and the second item to be changed to a line connecting the first item and the second item through the third item and at least one additional item.

If a user touches locations on the touch screen for a long period of time, the control unit may control the first item and second item to be generated on the touched locations on the touch screen.

If at least one of the items displayed on the touch screen is circumscribed clockwise or counterclockwise, the control unit may control the touch screen to be reduced or enlarged.

If the second item is double clicked or if the first item is dragged and dropped onto the second item, the control unit may guide a user along a route following the generated line.

The foregoing and/or other aspects and utilities of the present general inventive concept may be further achieved by providing a computer readable medium having the computer executable instructions for a method to provide a GUI, which may include the steps of generating on a touch screen a first item, a second item, and a line connection the first item and the second item, and further, if a location on the line is selected, generating at the selected location a third item capable of being moved on the screen.

### BRIEF DESCRIPTION OF THE DRAWINGS

These and/or other aspects and utilities of the present general inventive concept will become more apparent and more readily appreciated from the following description of the embodiments, taken in conjunction with the accompanying drawings of which:

FIGS. 1A to 1H are views illustrating a graphical user interface (GUI) to set a route from a starting point to a destination according to an exemplary embodiment of the present general inventive concept;

FIGS. 2A to 2F are views illustrating a GUI to set a route from a starting point to a destination through a via point according to an exemplary embodiment of the present general inventive concept;

FIGS. 3A to 3D are views illustrating a process of enlarging or reducing a map displayed on a touch screen according to an exemplary embodiment of the present general inventive concept;

FIGS. 4A to 4F are views illustrating a GUI to set a route when a via point lies outside the range of a map displayed on a touch screen according to an exemplary embodiment of the present general inventive concept;

FIGS. 5A to 5E are views illustrating a GUI to set a route from a starting point to a destination through a first via point and a second via point according to an exemplary embodiment of the present general inventive concept;

FIG. 6 is a block diagram illustrating a multimedia apparatus capable of providing a GUI; and

FIG. 7 is a flowchart illustrating a method of providing a GUI according to an exemplary embodiment of the present general inventive concept.

### DETAILED DESCRIPTION OF THE PREFERRED EMBODIMENTS

Reference will now be made in detail to exemplary embodiments of the present general inventive concept, with reference to the accompanying drawings, wherein like reference numerals refer to the like elements throughout.

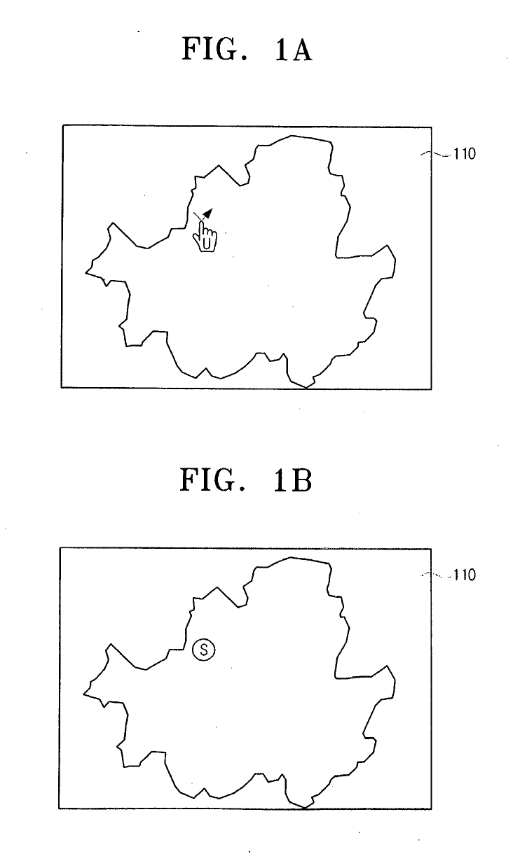

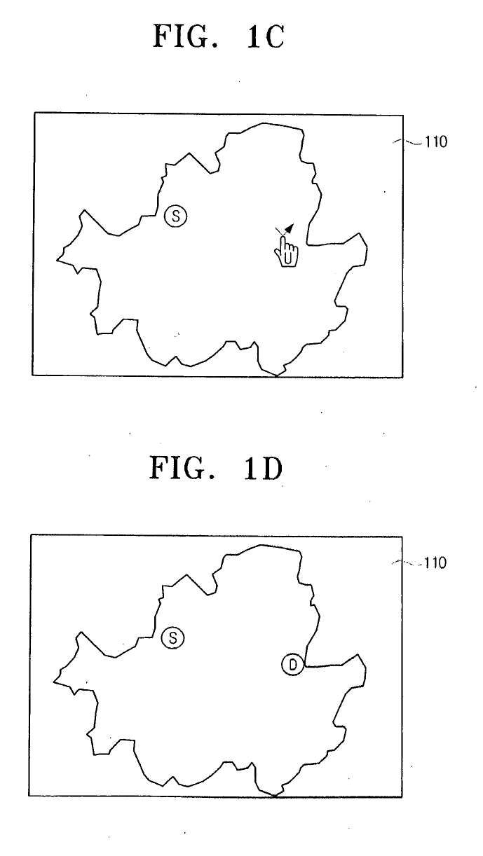

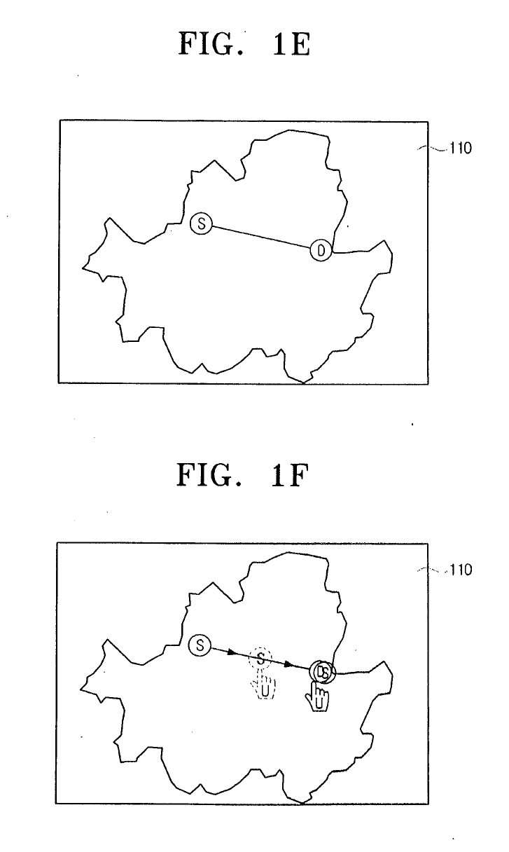

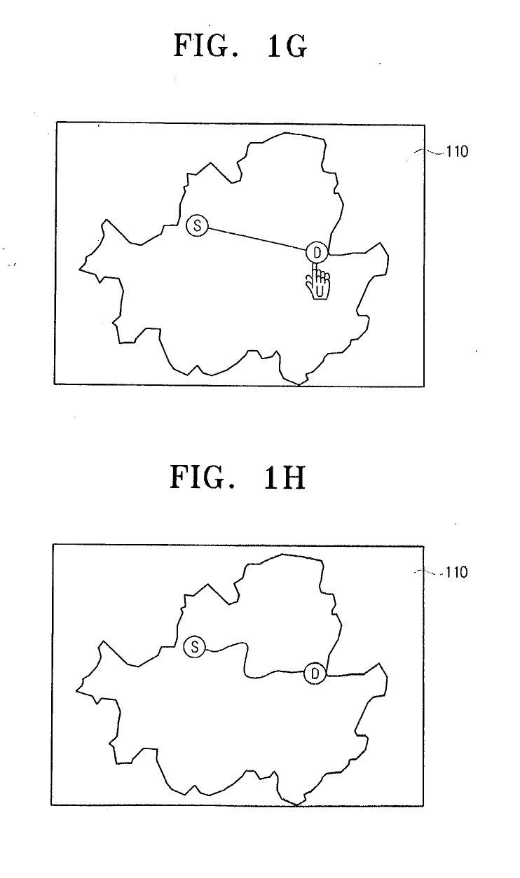

FIGS. 1A to 1H exemplarily illustrate a graphical user interface (GUI) to set a route from a starting point to a destination according to an exemplary embodiment of the present general inventive concept.

FIG. 1A illustrates a touch screen 110 which enables items to be generated or moved, and which is able to be enlarged or reduced according to user commands touched by a user U. The touch screen 110 displays routes to be set between and among generated items, and also shows a map so that the user U may search for a route to the final destination.

The user U may touch a location on the map displayed on the touch screen 110 to generate an item, as illustrated in FIGS. 1A and 1B. If the user touches the touch screen 110 for a predetermined period of time or longer, a basic item may appear on the touch screen 110, and alternatively if the user touches the touch screen 110 for less than the predetermined period of time, a general item or via item may appear on the touch screen 110.

For example, if the user U touches the touch screen 110 for one second or longer, a basic item may be generated and displayed on the touched location, and if the user U touches the touch screen 110 for less than one second, a general item or via item may be generated and displayed on the touched location.

Here, a basic item may refer to a start item S indicating a starting point or a destination item D indicating a destination. A via item may refer to an item which represents a via point between the starting point and the destination through which the user U desires to pass, and a general item may refer to an item unconnected with the route which the user U desires to set.

While the generated items are classified here using one second as the predetermined period of time, the present general inventive concept may also include any predetermined period of time, for example two or three seconds. Additionally, it is also possible to classify items according to the touch method, the number of times the touch screen 110 is touched, or the way in which generated items are moved on the touch screen 110, as further described below.

For example, if the user U touches a location of the map on the touch screen 110 for a predetermined period of time or longer, a start item S may be generated at the touched location, as illustrated in FIG. 1B. The position on the map on which the start item S is displayed indicates the starting point of the route which the user U desires to set.

After the start item S is generated, the user U may touch another location on the map on the touch screen 110 in order to generate a destination item D, as illustrated in FIG. 1C.

If the user U touches the touch screen 110 for a predetermined period of time or longer, the destination item D may be generated on the touched location on the touch screen 110, as illustrated in FIGS. 1C and 1D. The position on the map on which the destination item D is displayed indicates the destination of the route which the user U desires to set.

If both the start item S and destination item D are generated, a straight line connecting the start item S and destination item D automatically appears on the touch screen 110, as illustrated in FIG. 1E. While the straight line appears automatically in the exemplary embodiment of the present general inventive concept, the straight line may also be generated by additional manipulation by the user U.

The straight line may be used to display the distance between the starting point and the destination or to generate a via item A, rather than to indicate a route for which the user U desires to search.

For example, after the straight line appears on the touch screen 110, a numerical value and unit of distance representing the distance between the starting point and the destination, for example 10 km, may also appear together with the straight line on the touch screen 110.

If the user U wishes to search for a route without a via point, he or she may set a starting point and destination, confirm the set starting point and destination, and search for a route between the starting point and destination.

Here, the setting process refers to an initial operation of selecting a starting point and a destination and waiting to receive a command to search for a route. The setting process is performed through the operations illustrated in FIGS. 1A to 1D.

The confirming process may be performed, for example, by dragging and dropping the start item S onto the destination item D, as illustrated in FIG. 1F, or, for example, by double touching the destination item D, as illustrated in FIG. 1G.

The drag-and-drop operation of FIG. 1F and the double-touch operation of FIG. 1G may have other uses related to the route search. For example, the drag-and-drop operation of FIG. 1F may be used to search for a route having the shortest distance, and the double-touch operation of FIG. 1G may be used to search for a route having the shortest time.

However, the confirmation process refers to an operation of selecting a starting point and a destination point and inputting a command to search for a route. It is therefore possible to confirm a starting point and a destination only using the operations of FIGS. 1A to 1D without the need to perform the operations of FIGS. 1F and 1G.

For example, if the user U generates the start item S and destination item D using the operations of FIGS. 1A to 1D, a route connecting the start item S to the destination item D, as illustrated in FIG. 1H, may instantly appear on the touch screen 110 forming the route from the starting point to the destination point, and the operations of FIGS. 1E to 1G may be omitted.

The user U may be guided along the route using speakers connected to a multimedia apparatus including the touch screen 110, or using the touch screen 110.

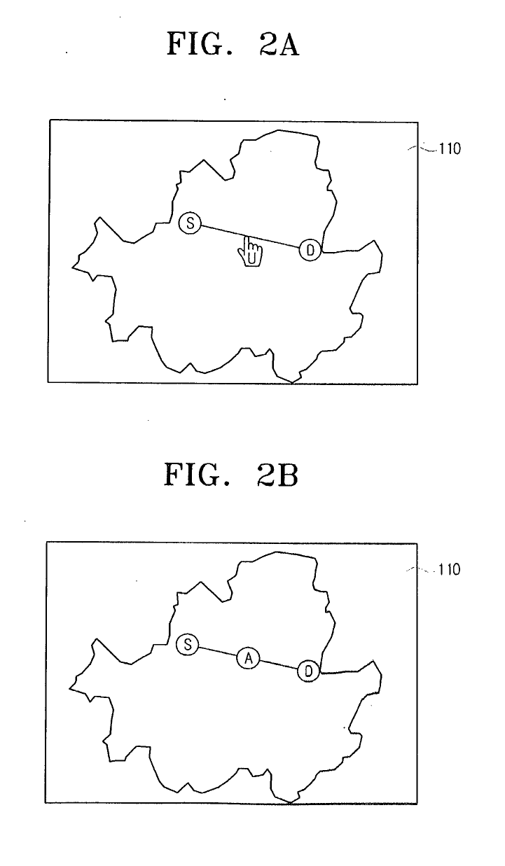

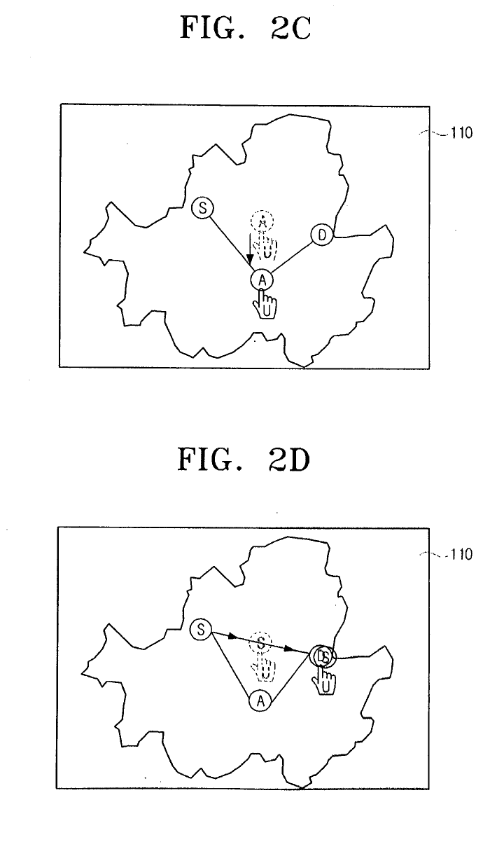

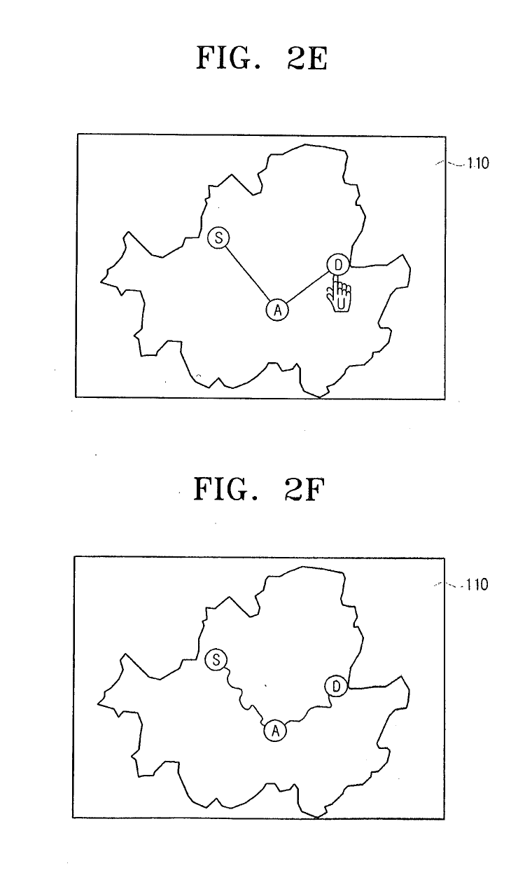

FIGS. 2A to 2F exemplarily illustrate a GUI to set a route from a starting point to a destination through a via point according to an exemplary embodiment of the present general inventive concept.

If the start item S and destination item D are set as illustrated in FIG. 1E, the user U may set a via point using operations illustrated in FIGS. 2A to 2F without the need to confirm the starting point and destination and search for a route.

To generate a via item A, the user U may lightly touch the line connecting the start item S and destination item D, as illustrated in FIG. 2A. For example, if the user U lightly touches the line for a predetermined period of time or less, the via item A is generated at the touched location, and the line connecting the start item S and destination item D is automatically divided into a line connecting the start item S and via item A and a line connecting the destination item D and via item A, as illustrated in FIG. 2B.

While the via item A is generated by lightly touching the touch screen 110 in the exemplary embodiment of the present general inventive concept, other methods may be used to create via item A. For example, if the line connecting the start item S and destination item D is touched twice, via item A may also appear at the touched location.

This operation of generating a via item A may be performed after the starting point and destination are set as illustrated in FIG. 1E, but it is also possible to generate a via item A after the starting point and destination are confirmed as illustrated in FIG. 1H.

In the latter case, if the user U lightly touches the line connecting the start item S and destination item D, a via item A appears at the touched location, and the line connecting the start item S and destination item D is automatically divided into a line connecting the start item S and via item A and a line connecting the destination item D and via item A, as illustrated in FIG. 2B, in the same manner as in the former case.

However, if the via item A is generated after the confirmation process, the start item S, via item A and destination item D may not be aligned with each other.

When the via item A appears on the touch screen 110 as illustrated in FIG. 2B, the user U may set a via point by dragging the via item A, as illustrated in FIG. 2C.

However, this is only an example provided for convenience of description, and other methods may thus be used to set a via point. For example, a via point may be set not only by touching the line, generating a via item and dragging the generated via item as illustrated in FIGS. 2A to 2C, but also by touching and dragging the line and causing a via item to be disposed at a position which a user desires to set.

If the via point is set, the user U may confirm the set starting point, via point and destination and may search for a route from the starting point to the destination.

The operation of confirming the starting point, via point and destination may be performed, for example, by dragging and dropping the start item S onto the destination item D, as illustrated in FIG. 2D, or by double touching the destination item D, as illustrated in FIG. 2E.

The drag-and-drop operation and the double-touch operation have been described above with reference to FIGS. 1F and 1G, so further description thereof is omitted. As described above, if a start item and destination item are created, a route illustrated in FIG. 1H may be instantly displayed. Accordingly, it is possible to select a location on the route of FIG. 1H and generate a via item.

If the user U desires to change the position of the generated via item, he or she may drag the via item as illustrated in FIG. 2C.

If the via item is disposed at another location after dragging, the user U may confirm the starting point, via point and destination by, for example, the drag-and-drop operation of FIG. 2D or by the double-touch operation of FIG. 2E. Additionally, the change in the position of the via item may cause the starting point, via point and destination to be automatically confirmed.

Accordingly, a route from the start item S to the via item A and a route from the via item A to the destination item D may be displayed on the touch screen 110, as illustrated in FIG. 2F, making it possible to guide a user along the route to the final destination.

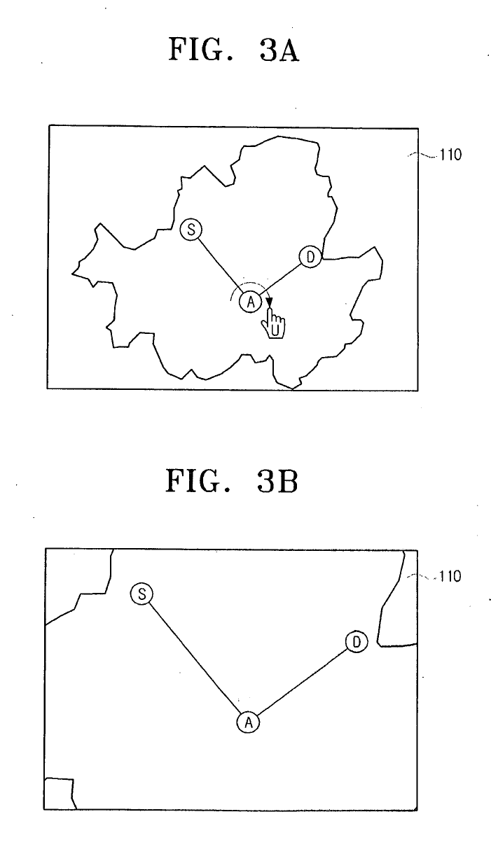

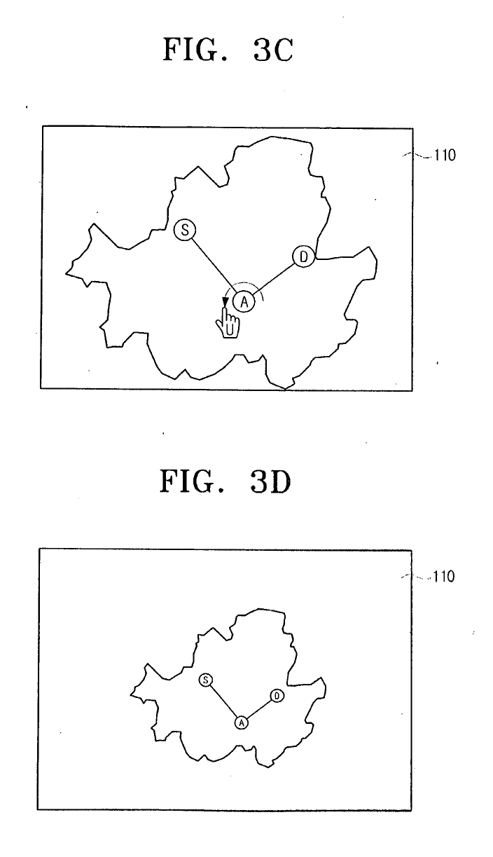

FIGS. 3A to 3D exemplarily illustrate a process of enlarging or reducing the map displayed on the touch screen 110.

For example, if the user U moves his or her fingertip clockwise around the via item A while touching the touch screen 110, as illustrated in FIG. 3A, the map is enlarged and displayed on the touch screen 110, as illustrated in FIG. 3B. Accordingly, the user U may change the position of via item A more precisely using the enlarged map illustrated in FIG. 3B. Additionally, the enlarged map may also be used to change the position of start item S and destination item D.

Alternatively, if the user U moves his or her fingertip counterclockwise around the via item A while touching the touch screen 110, as illustrated in FIG. 3C, the map is reduced and displayed on the touch screen 110, as illustrated in FIG. 3D. Accordingly, the user U can change the position of via item A more generally using the reduced map illustrated in FIG. 3D.

Although the map may be enlarged or reduced by moving one's finger around the perimeter of the via item A in the exemplary embodiment of the present general inventive concept, this is only an example provided for convenience of description. It is also possible to enlarge or reduce the map by moving one's finger around the perimeter of the start item S, or the perimeter of the destination item D, or the perimeter of a general item, or any point on the map. Additionally, it is possible to enlarge or reduce the map while centering the map on another item around which the user moves his or her finger, such as a general item, or any point on the map, rather than enlarging or reducing the entire map.

Furthermore, the map may be reduced by moving one's finger clockwise around the perimeter of via item A, or may be enlarged by moving one's finger counterclockwise around the perimeter of via item A, in a manner different from that described above.

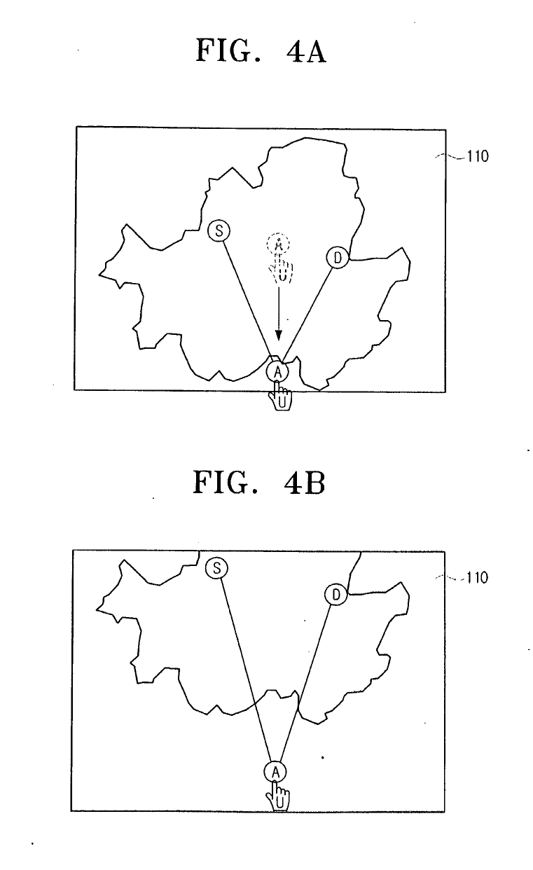

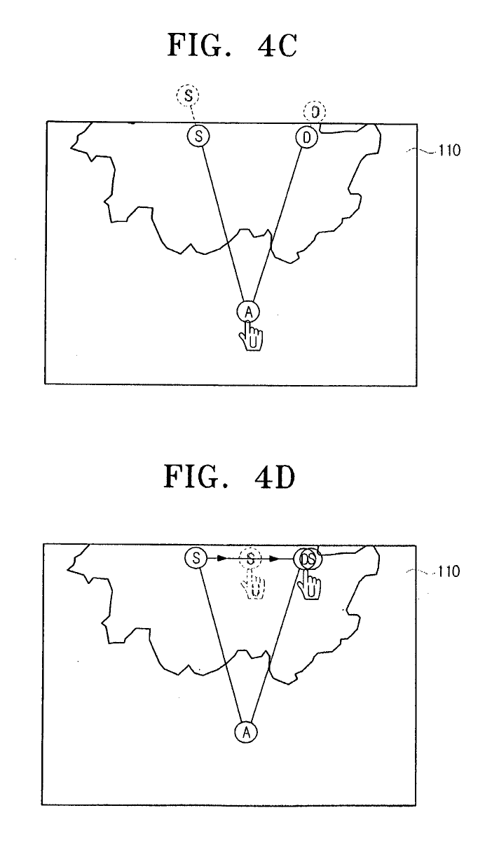

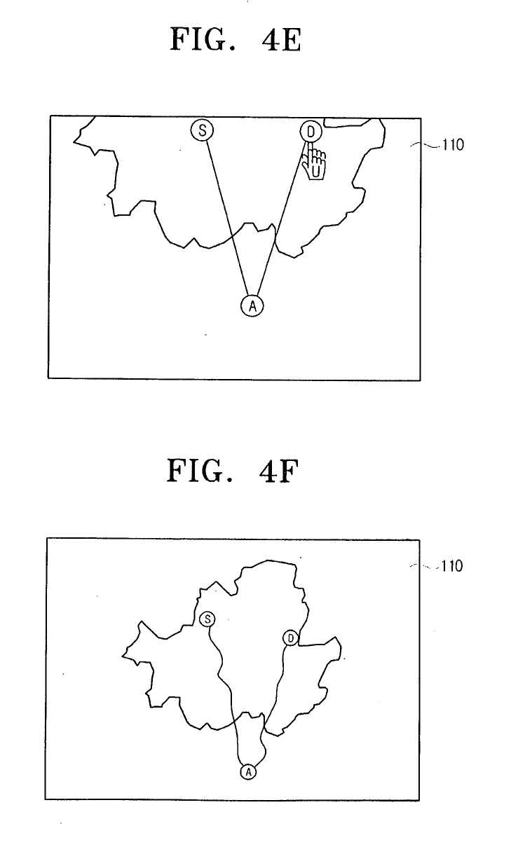

FIGS. 4A to 4F illustrate an exemplary GUI to set a route when a via point lies outside the range of a map displayed on the touch screen 110.

For example, if a via point which the user U desires to set lies outside the range of a map currently displayed on the touch screen 110, the user U may drag the via item A toward the edge of the map, as illustrated in FIG. 4A.

FIG. 4A exemplarily illustrates a situation in which a via point which the user U desires to set is located in the south of the currently displayed map. Accordingly, the user U may drag the via item A toward the south edge of the map so that the via point may be represented by the via item A on the touch screen 110. Additionally, if via item A is dragged to the south edge of the map, an area to the south of that displayed on the map may automatically appear on the touch screen 110, as illustrated in FIG. 4B.

The edge of the map may correspond to east, west, south and north of the map. It is also possible to set detailed numerical values according to commands of the user U. For example, if via item A is dragged to within approximately 1 centimeter of the southeast of the map on the touch screen 110 as illustrated in FIG. 4A, the area to the south of that displayed on the map may automatically appear on the touch screen 110, as illustrated in FIG. 4B.

Additionally, if via item A is dragged to within approximately 1 centimeter of the south of the map on the touch screen 110 as illustrated in FIG. 4A, northern parts of the map disappear, but an area to the south of the area displayed on the map appears on the touch screen 110 instead, as illustrated in FIG. 4B.

Therefore, it is possible for the user U to set via item A to be placed on a desired position on the touch screen 110 without needing to perform additional operations, even when a via point which he or she desires to set lies beyond the area of the map currently displayed on the touch screen 110.

While the via item A may be moved to the south of the map in this example, the present general inventive concept also applies to situations in which the via item A is able to move in other directions such as east, west, north, northeast, southwest, and so forth.

As illustrated in FIG. 4B, a via point which the user U desires to set may be displayed on a single screen together with the starting point and destination that have been set by the user U. In this situation, if the via point is located further south than as illustrated in FIG. 4B, the map may further show the southern area so that the starting point and destination may disappear from the touch screen 110.

FIG. 4C illustrates a situation in which the start item S and destination item D are regenerated on the top of the touch screen 110. In FIG. 4C, the start item S and destination item D indicated by dotted lines represent the actual starting point and actual destination, respectively, and the start item S and destination item D indicated by solid lines represent a virtual starting point and a virtual destination that will take the place of the actual starting point and destination, respectively.

The actual positions of the start item S and destination item D indicated by the dotted lines are not displayed on the touch screen 110, but the start item S and destination item D are placed at the top of the touch screen 110 in FIG. 4C. The start item S and destination item D regenerated and indicated by the solid lines are illustrated virtually, and these provide an indication to the user U of the actual locations of the starting point and destination point. Accordingly, the user U may roughly judge where the actual starting point and destination are located while viewing the start item S and destination item D regenerated and indicated by the solid lines on the touch screen 110, even when the actual starting point and destination are not displayed on the map.

Additionally, in this situation, the color or brightness of the regenerated items may be adjusted in order to provide an indication to the user U where the actual starting point and destination are located. For example, the start item S may be made darker in order to inform the user U that the actual starting point is far from the regenerated start item S. Alternatively, the start item S may be made brighter in order to inform the user U that the actual starting point is located near to the regenerated start item S.

As illustrated in FIG. 4C, the start item S is regenerated at a position in which a straight line connecting the actual starting point and the via point indicated by the via item A crosses the edge of the touch screen 110. Similarly, the destination item D is regenerated at a position in which a straight line connecting the actual destination and the via point indicated by the via item A crosses the edge of the touch screen 110.

If via item A moves further south than that of FIG. 4C when the via point is set, the distance between the regenerated start item S and regenerated destination item D may be reduced. Alternatively, if the via item A does not move as far south as that of FIG. 4C when the via point is set, the distance between the regenerated start item S and regenerated destination item D may become longer.

Accordingly, even when the actual starting point and destination are caused to move beyond the currently displayed map, the direction or position of the actual starting point and destination may be indicated to the user using the regenerated start item S and regenerated destination item D.

The operation of confirming the starting point, via point and destination may be performed either by dragging and dropping the regenerated start item S onto the regenerated destination item D, as illustrated in FIG. 4D, or by double touching the regenerated destination item D, as illustrated in FIG. 4E. The drag-and-drop operation of FIG. 4D and the double-touch operation of FIG. 4E are performed in a similar manner as those of FIGS. 2D and 2E, as described above.

As a result of confirming the starting point, via point and destination using the drag-and-drop operation or double-touch operation, a route connecting the start item S and via item A and a route connecting the via item A and destination item D are displayed on the touch screen 110, as illustrated in FIG. 4F, so it is possible to guide a user along the route to the final destination through the via point.

In this situation, the map may be reduced and displayed as illustrated in FIG. 4F in order to display a route between the start item S representing the actual starting point, the destination item D representing the actual destination and the via item A representing the via point. Alternatively, the map may be displayed without being reduced, so that a route between the regenerated start item S, regenerated destination item D and via item A may be displayed.

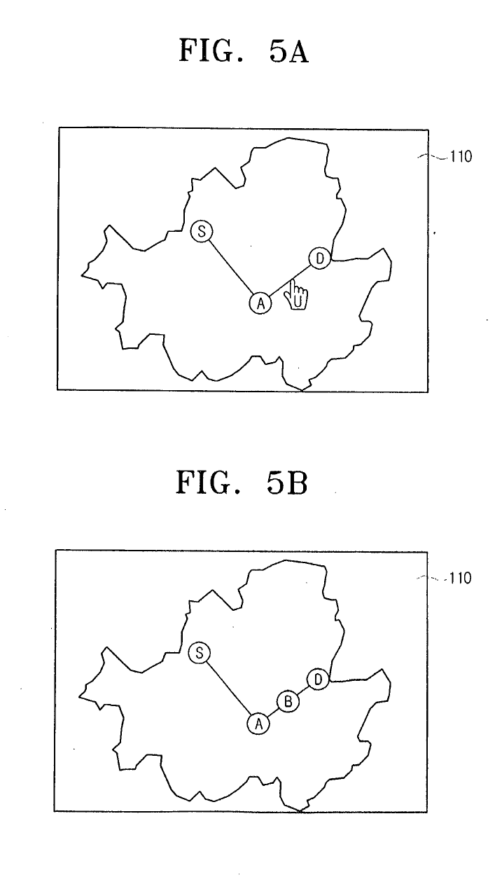

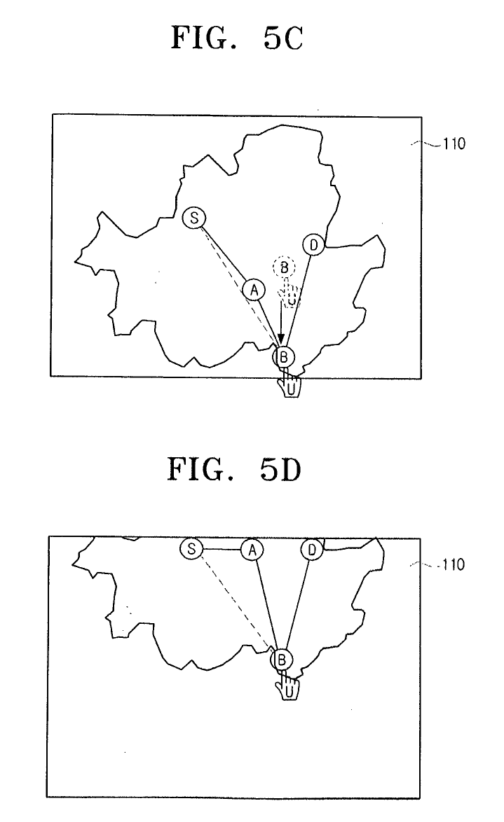

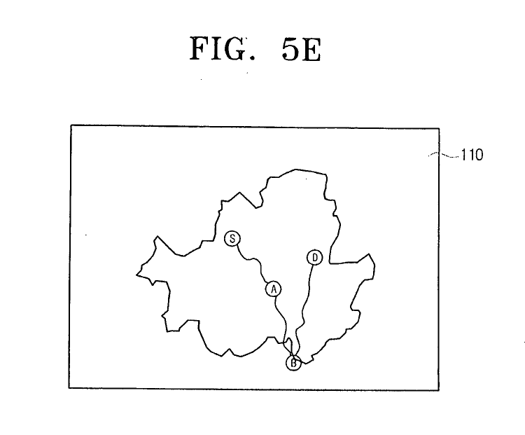

FIGS. 5A to 5E are views illustrating a GUI to set a route from a starting point to a destination through a first via point and second via point.

After the start item S, via item A and destination item D are generated and the starting point, via point and destination are set as illustrated in FIG. 2C, the user U may set an additional via point as illustrated in FIGS. 5A to 5E before confirming the set starting point, via point and destination and searching for a route.

Hereinafter, in order to facilitate description of the present general inventive concept, the via point, additional via point, via item A and additional via item B are referred to as a first via point, a second via point, a first via item A and a second via item B, respectively.

In order to generate a second via item B, the user U may lightly touch a line connecting the start item S and first via item A or a line connecting the first via item A and destination item D, as illustrated in FIG. 5A.

If the user U touches the line connecting the start item S and first via item A, a route is created which enables the user U to reach the destination through the second via point and via the first via point. Alternatively, if the user U touches the line connecting the first via item A and destination item D, a route is created so that the user U is able to move from the starting point to the destination through the first via point and via the second via point. Hereinafter, the latter example will be more fully described.

If the user U touches the line connecting the first via item A and destination item D for a predetermined period of time or less, the second via item B is generated at the touched location, as illustrated in FIG. 5B. Additionally, the line connecting the first via item A and destination item D is automatically divided into a line connecting the first via item A and second via item B, and a line connecting second via item B and destination item D.

In this situation, second via item B may be generated after the starting point, first via point and destination are set, as described above, but it is also possible to generate second via item B after the starting point, first via point and destination are confirmed.

If second via item B is generated as illustrated in FIG. 5B, the user U may set a second via point by dragging second via item B, as illustrated in FIG. 5C. If second via item B is dragged to within approximately 1 centimeter of the southeast of the map on the touch screen 110 in a manner similar to that illustrated in FIG. 4A, an area to the south of that displayed on the map automatically appears on the touch screen 110 illustrated in FIGS. 5C and 5D.

Additionally, even when the second via point which the user U desires to set lies outside the range of a map currently displayed on the touch screen 110, the user U may set the second via point by placing first via item A on a desired position on the map without needing additional operations.

Similar to as described with reference to FIG. 4C, the start item S, first via item A and destination item D are regenerated in place of an actual starting point, first via point and destination, as illustrated in FIG. 5D.

Therefore, after routing is completed, a route from the start item S to the first via item A, a route from the first via item A to the second via item B, and a route from the second via item B to the destination item D are displayed on the touch screen 110, as illustrated in FIG. 5E, so it is possible to guide a user along the route to the final destination through the first via point and second via point.

While the operation of creating a route when there is no via point or when one or two via points are added has been described in exemplary embodiments of the present general inventive concept, there is no limitation thereto. Accordingly, the present general inventive concept is also applicable to a situation in which at least three via points are added.

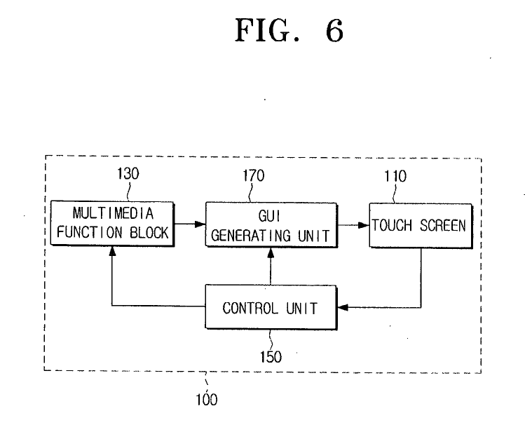

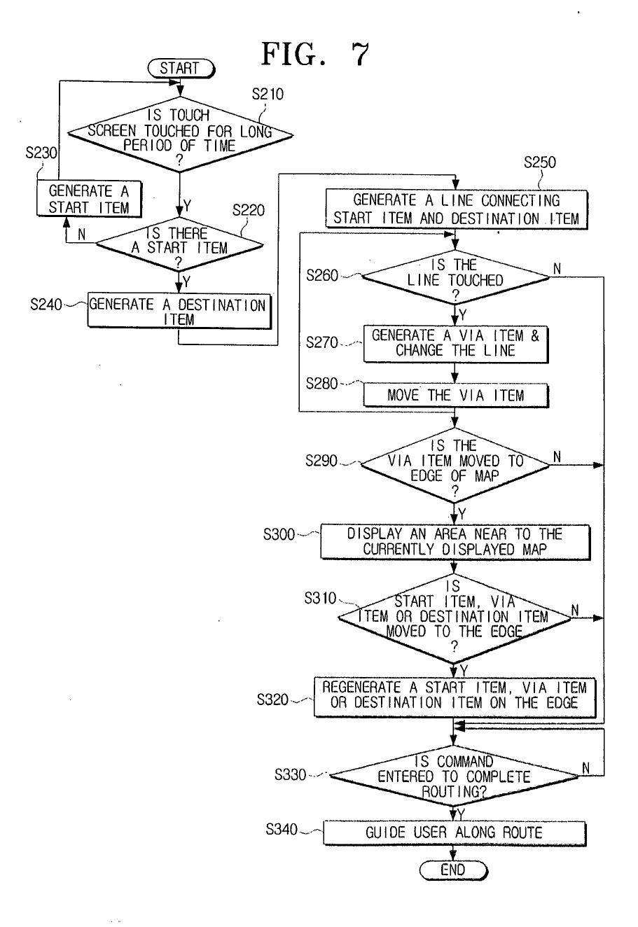

FIG. 6 is a block diagram illustrating a multimedia apparatus 100 capable of providing the GUIs described above. The multimedia apparatus of FIG. 6 includes a touch screen 110, a multimedia function block 130, a control unit 150 and a GUI generating unit 170.

The multimedia function block 130 carries out general functions of multimedia apparatus 100, including playback of content such as moving images, still images, music or text, and guiding a user along a route according to a route search command input by the user U. The type of function performed by the multimedia function block 130 is determined according to the application of the multimedia apparatus. In an exemplary embodiment of the present general inventive concept, the multimedia apparatus functions to guide a user along a route on a map, so the multimedia function block 130 is able to provide guidance to a user along a route in response to a route search command input by the user U.

The GUI generating unit 170 generates GUIs such as have been described above, and adds the generated GUIs, such as items or routes, to a map output from the multimedia function block 130.

The touch screen 110 is enabled to display GUI-incorporated video output from the GUI generating unit 170, and to receive user operations input by, for example, touching or dragging and dropping.

The control unit 150 controls the operation of the multimedia function block 130 according to the user input received through the touch screen 100 or other possible input mechanisms (not illustrated).

The control unit 150 controls the GUI generating unit 170 so that the GUI is displayed on the touch screen 100 according to the user input. Operational aspects of the GUI have been described above.

The multimedia apparatus of FIG. 6 may be employed in a navigation apparatus to guide a user along a route on a map.

Hereinafter, a method by which the multimedia apparatus of FIG. 6 provides a GUI will be described in detail with reference to FIG. 7. FIG. 7 is a flowchart illustrating a method of providing a GUI according to an exemplary embodiment of the present general inventive concept.

The control unit 150 determines whether a portion of a map displayed on the touch screen 110 is touched for a long period of time in operation S210, and if so, in operation S210-Y, the control unit 150 becomes ready to generate basic items.

As described above, the basic item may be a start item S or destination item D, and thus the control unit 150 determines whether the start item S has been generated in operation S220.

If it is determined that the start item S has not been generated in operation S220-N, the control unit 150 generates the start item S on the touch screen 110 in operation S230. The start item S may be generated on a location of the map touched by the user U at operation S210.

Alternatively, if it is determined that the start item S has been generated in operation S220-Y, the control unit 150 generates the destination item D on the touch screen 110 in operation S240. In this situation, the destination item D may be generated on the location on the map touched by the user U at operation S210, in the a manner similar to operation S230.

Subsequently, the control unit 150 generates a line connecting the start item S and destination item D to appear automatically on the touch screen 110 in operation S250.

The control unit 150 determines whether the user U touches the line connecting the start item S and destination item D in operation S260. Here, the user U may lightly touch the line connecting the start item S and destination item D, as described above.

If it is determined that the line connecting the start item S and destination item D is touched by the user U in operation S260-Y, the control unit 150 generates a via item A at the touched location in operation S270. During operation S270, the control unit 150 causes the line connecting the start item S and destination item D to be divided into a line connecting the start item S and via item A and a line connecting the via item A and destination item D.

The user U may move the generated via item A on the map displayed on the touch screen 110. Accordingly, if a command to move the via item A is input, the control unit 150 moves the via item A in a direction selected by the user U in operation S280.

Although in this exemplary embodiment a single via item A is generated and displayed on touch screen 110, operations S260, S270 and S280 described above may be repeated. If operations S260, S270 and S280 are repeated, via items may be generated on the touch screen 110 as many times as the operations are repeated, and the user U may move the generated via items.

If the via item A is moved in the direction selected by the user U in response to the command to move the via item A, the control unit 150 determines whether the via item A is moved towards the edge of the map in operation S290.

If it is determined that the via item A is moved towards the edge of the map in operation S290-Y, the control unit 150 displays an area near to the currently displayed map towards which the via item A is moved in operation S300. Accordingly, the via item A may continue to appear on the touch screen 110.

When displaying the area near to the currently displayed map, the control unit 150 also determines whether the start item S, via item A or destination item D is moved towards the edge of the map in operation S310. Here, the via item A in operation S310 is different from the via item A moved by the user U in operation S290.

Since a plurality of via items may be generated by repeating operations S260, S270 and S280, as described above, the via item A in operation S310 is moved by the user U to the edge of the map in a direction opposite the direction in which the via item A is moved by the user U in operation S290.

Referring back to FIG. 5B, the via item A in operation S310 corresponds to the first via item A, and the via item A in operation S290 corresponds to the second via item B.

If it is determined that the start item S, via item A or destination item D is moved towards the edge of the map in operation S310-Y, the control unit 150 regenerates a start item S, via item A or destination item D on the edge in operation S320.

Subsequently, the control unit 150 determines whether the user U enters a command to complete routing in operation S330.

If it is determined that the command to complete routing is input, the control unit 150 guides a user along the confirmed route in operation S340.

While the exemplary embodiments described above employ touch screen 110 to illustrate the method of providing a GUI to generate items and move the generated items according to the present general inventive concept, it is only employed for the sake of explanation. Accordingly, the present general inventive concept can also be applied to a GUI to generate items and move the generated items using devices other than the touch screen 110, for example a mouse or a touch pad. Additionally, according to the exemplary embodiments of the present general inventive concept, the touch screen is used to receive user commands and to provide a user with user desired information, so it is possible to provide a GUI, which provides the user with the ability to manipulate items more conveniently and more intuitively.

Although exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of providing a graphical user interface (GUI), the method comprising:
if a command to generate a first item and a second item is received, generating the first item, the second item and a line connecting the first item and the second item on a screen; and
if a location on the line is selected, generating at the selected location a third item capable of moving on the screen.

2. The method as claimed in claim 1, wherein the screen comprises a map to search for a route.

3. The method as claimed in claim 2, wherein the line connecting the first item and the second item is a virtual route, which connects a position of the first item to a position of the second item using a straight line on the map.

4. The method as claimed in claim 2, wherein the line connecting the first item and the second item is a route from the position of the first item to the position of the second item.

5. The method as claimed in claim 2, wherein the first item, second item and third item are a start item representing a starting point, a destination item representing a destination and a via item representing a via point, respectively.

6. The method as claimed in claim 1, further comprising:
if the third item is moved towards an edge of the screen, continuously displaying on the screen an area near to the edge of the screen towards which the third item is moved, and controlling the third item to continue to be moved.

7. The method as claimed in claim 6, further comprising:
if the first item or second item lies outside the scope of the area displayed on the screen, controlling the first item to be regenerated at a position along a virtual line connecting the first item and the third item, and controlling the second item to be regenerated at a position along a virtual line connecting the second item and the third item.

8. The method as claimed in claim 1, wherein the third item is able to be moved on the screen by a dragging operation.

9. The method as claimed in claim 1, further comprising:
if the third item is generated, controlling the line connecting the first item and the second item to be divided into a line connecting the first item and the third item and a line connecting the third item and the second item.

10. The method as claimed in claim 1, further comprising:
if a location on the lines generated on the screen is additionally selected, controlling at least one additional item capable of moving on the screen to be generated on the selected location.

11. The method as claimed in claim 10, further comprising:
if the additional items are generated, controlling the line connecting the first item and the second item to be changed to a line connecting the first item and the second item through the third item and the at least one additional item.

12. The method as claimed in claim 1, wherein, if a user presses locations on the screen for a long period of time, the first item and second item are generated on the pressed locations on the screen.

13. The method as claimed in claim 1, further comprising:
if at least one of the items displayed on the screen is circumscribed clockwise or counterclockwise, controlling the screen to be reduced or enlarged.

14. The method as claimed in claim 1, further comprising:
if the second item is double clicked or if the first item is dragged and dropped onto the second item, guiding a user along a route following the generated line.

15. The method as claimed in claim 1, wherein the screen comprises a touch screen through which a user command is input by touch.

16. A multimedia apparatus comprising:
a touch screen; and
a control unit to control a first item, a second item and a line connecting the first item and the second item to be generated on the touch screen, if a command to generate the first item and second item is received, and to control a third item capable of moving on the touch screen to be generated on a location on the line, if the location on the line is selected.

17. The multimedia apparatus as claimed in claim 16, wherein the touch screen displays a map to enable a search for a route.

18. The multimedia apparatus as claimed in claim 17, wherein the line connecting the first item and the second item is a virtual route, which connects a position of the first item to a position of the second item using a straight line on the map.

19. The multimedia apparatus as claimed in claim 17, wherein the line connecting the first item and the second item is a route from the position of the first item to the position of the second item.

20. The multimedia apparatus as claimed in claim 17, wherein the first item, second item and third item are a start item representing a starting point, a destination item representing a destination and a via item representing a via point, respectively.

21. The multimedia apparatus as claimed in claim 16, wherein, if a command to move the third item to an edge of the touch screen is received, the control unit continuously displays on the touch screen an area near to the edge to which the third item is moved, and controls the third item to continue to be moved.

22. The multimedia apparatus as claimed in claim 21, wherein, if the first item or second item lies outside the scope of the area displayed on the screen, the control unit controls the first item to be regenerated at a position along a virtual line connecting the first item and the third item, and controls the second item to be regenerated at a position along a virtual line connecting the second item and the third item.

23. The multimedia apparatus as claimed in claim 16, wherein the control unit controls the third item to be moved on the touch screen by a dragging operation.

24. The multimedia apparatus as claimed in claim 16, wherein, if the third item is generated, the control unit controls the line connecting the first item and the second item to be divided into a line connecting the first item and the third item and a line connecting the third item and the second item.

25. The multimedia apparatus as claimed in claim 16, wherein, if a location on the lines generated on the touch screen is additionally touched, the control unit controls at least one additional item capable of moving on the screen to be generated at the touched location.

26. The multimedia apparatus as claimed in claim 25, wherein, if the at least one additional item is generated, the control unit controls the line connecting the first item and the second item to be changed to a line connecting the first item and the second item through the third item and at least one additional item.

27. The multimedia apparatus as claimed in claim 16, wherein, if a user touches locations on the touch screen for a long period of time, the control unit controls the first item and second item to be generated on the touched locations on the touch screen.

28. The multimedia apparatus as claimed in claim 16, wherein, if at least one of the items displayed on the touch screen is circumscribed clockwise or counterclockwise, the control unit controls the touch screen to be reduced or enlarged.

29. The multimedia apparatus as claimed in claim 16, wherein, if the second item is double clicked or if the first item is dragged and dropped onto the second item, the control unit guides a user along a route following the generated line.

30. A computer readable medium having computer executable instructions for a method to provide a GUI, comprising: generating on a touch screen a first item, a second item, and a line connecting the first item and the second item; and
if a location on the line is selected, generating at the selected location a third item capable of being moved on the screen.

31. The computer readable medium of claim 30 wherein the first item is a start point and the second item is a destination point.

32. The computer readable medium of claim 30 wherein the line is a route.

33. The computer readable medium of claim 30 wherein the third item is a via point.

34. The computer readable medium of claim 30 wherein if the third item is moved, the line remains connected to the first item, the second item and the third item.

35. The computer readable medium of claim 30 further comprising, if the third item is moved near an edge of the touch screen, generating a virtual start point and a virtual destination point.

36. A method of providing a route on a GUI, the method comprising:
displaying a GUI on a display, wherein the display enables a user to designate a start point and a destination point;
generating a route between a designated start point and destination point;
permitting a user to select a via point on the route, wherein the via point may be moved on the display to change the route.

37. The method of claim 36 wherein the step of generating a route further comprises searching for a route from the start point to the destination point.

38. The method of claim 37 wherein the step of searching further comprises searching for the shortest time route from the start point to the destination point.

39. The method of claim 37 wherein the step of searching further comprises searching for the shortest distance route from the start point to the destination point.

40. A multimedia apparatus to generate a GUI, comprising:
a GUI generating unit, configured to generate a start point, a destination point, and a route from the start point to the destination point; and
a touch screen, operably connected to the GUI generating unit, to display the start point, the destination point, and the route, and to permit a via point to be selected on the route, wherein the via point can be moved on the touch screen.
